(19) United States
(12) Patent Application Publication
(10) Pub. No.: US 2005/0229977 A1
(43) Pub. Date: Oct. 20, 2005

(54) Flow regulating valve assembly

(76) Inventors: Yang Li, Troy, MI (US); Jeffrey Schmidt, Southgate, MI (US); Ted Jurczak, Clawson, MI (US); Daniel Bovinich, Rochester Hills, MI (US)

Correspondence Address: ENERGY CONVERSION DEVICES, INC., 2956 WATERVIEW DRIVE, ROCHESTER HILLS, MI, 48309, US

(21) Appl. No.: 10/826,855

(22) Filed: Apr. 16, 2004

(51) Int. Cl. F16K 15/02

(52) U.S. Cl. 137/517

(57) ABSTRACT

A fluid flow regulating valve assembly whereby the flow of the fluid entering the valve is maintained, restricted, or ceased based on the pressure differential between the fluid source and the fluid destination, where the pressure of the fluid at the source is equal to or greater than the fluid destination. The valve assembly is particularly useful for supplying gaseous hydrogen to metal hydride hydrogen storage vessels.

### FIELD OF THE INVENTION

The present invention generally relates to fluid flow regulating valve assembly. More specifically, the present invention relates to a fluid flow regulator whereby the flow of the fluid entering the valve is maintained, restricted, or ceased based on the pressure differential between the fluid source and the fluid destination, where the pressure of the fluid source is equal to or greater than the fluid destination.

### BACKGROUND

With the recent developments in fuel cells and hydrogen powered internal combustion engines, hydrogen is becoming increasingly more viable as an everyday fuel. For hydrogen to be accepted as an everyday fuel, hydrogen storage and refueling systems must be designed with efficiency and safety in mind. While hydrogen has wide potential application as a fuel, a major drawback in its utilization, especially in mobile uses such as the powering of vehicles, has been the lack of acceptable hydrogen storage medium. Conventionally, hydrogen has been stored in a pressure vessel under a high pressure or stored as a cryogenic liquid, being cooled to an extremely low temperature. Storage of hydrogen as a compressed gas or liquid to date has involved the use of large and bulky vessels.

Additionally, transfer is very difficult, since the hydrogen is stored in a large-sized vessel; amount of hydrogen stored in a vessel is limited, due to low density of hydrogen. Furthermore, storage as a liquid presents a serious safety problem when used as a fuel for motor vehicles since hydrogen is extremely flammable. Liquid hydrogen also must be kept extremely cold, below −253° C., and is highly volatile if spilled. Moreover, liquid hydrogen is expensive to produce and the energy necessary for the liquefaction process is a major fraction of the energy that can be generated by burning the hydrogen.

Alternatively, certain metals and alloys have been known to permit reversible storage and release of hydrogen. In this regard, they have been considered as a superior hydrogen-storage material, due to their high hydrogen-storage efficiency. Storage of hydrogen as a solid hydride can provide a greater volumetric storage density than storage as a compressed gas or a liquid in pressure tanks. Also, hydrogen storage in a solid hydride presents fewer safety problems than those caused by hydrogen stored in containers as a gas or a liquid. Solid-phase metal or alloy system can store large amounts of hydrogen by absorbing hydrogen with a high density and by forming a metal hydride under a specific temperature/pressure or electrochemical conditions, and hydrogen can be released by changing these conditions. Metal hydride systems have the advantage of high-density hydrogen-storage for long periods of time, since they are formed by the insertion of hydrogen atoms to the crystal lattice of a metal. A desirable hydrogen storage material must have a high gravimetric and volumetric density, a suitable desorption temperature/pressure, good kinetics, good reversibility, resistance to poisoning by contaminants including those present in the hydrogen gas and be of a relatively low cost. If the material fails to possess any one of these characteristics it will not be acceptable for wide scale commercial utilization.

When hydrogen is absorbed into a hydrogen storage material, a heat of hydride formation is produced. The heat of hydride formation produced by the absorption of hydrogen into the hydrogen storage alloy can hinder the rate at which hydrogen is absorbed into the hydrogen storage material. Many metal hydride storage systems have been designed with this in mind as many designs incorporate heat transfer means to effectively remove the heat of hydride formation as it is produced. While these systems have proven to be effective in removing the heat of hydride formation, problems may still occur where large amounts of hydrogen are supplied to the hydrogen storage alloy thereby producing large amounts of heat which cannot be readily removed even with the use of heat transfer means. One solution to ensure that too much heat of hydride formation is not produced, it to regulate the flow rate of hydrogen into the metal hydride hydrogen storage unit.

Many fluid flow regulator valves exist in the prior art and may be used to regulate the flow of hydrogen into metal hydride hydrogen storage containers. Such flow regulator valves may be manual, used in conjunction with process controls, or actuated by the flow of the fluid itself. However, these flow regulators may be expensive, bulky, complicated, or may not be suitable for certain applications.

### SUMMARY OF THE INVENTION

The present invention discloses a valve assembly for regulating the flow of hydrogen gas in a metal hydride hydrogen storage system. The valve assembly comprises a housing having one or more entrance ports through which fluid enters the valve assembly and one or more exit ports through which fluid exits the valve assembly, the one or more entrance ports and the one or more exit ports being in fluid communication via a chamber extending from the one or more entrance ports to the one or more exit ports within the housing. The valve assembly further comprises a plug disposed within the chamber in a normally open position, and a translating member, such as a spring, in mechanical communication with the plug, the translating member biasing the plug in the direction of the one or more entrance ports. The plug and the translating member cooperate to provide a flow resistance actuated by the force exerted on the plug by fluid entering the valve assembly such that the flow resistance increases with increased force exerted on the plug. The plug may have one or more fluid flow channels longitudinally disposed within said plug which allow fluid to flow through the plug. The one or more exit ports may receive at least a portion of the plug upon force being applied on the plug by the fluid entering the one or more one entrance port. The side of said plug facing said second port has a conical configuration.

The present invention also discloses a metal hydride hydrogen storage system comprising a source of gaseous hydrogen, a pressure containment vessel at least partially filled with a hydrogen storage alloy, and a pressure regulating valve providing gaseous communication between said source of gaseous hydrogen and said pressure containment vessel. The hydrogen storage alloy may be selected from Rare-earth metal alloys, Misch metal based alloys, zirconium based alloys, titanium based alloys, magnesium based alloys, magnesium/nickel based alloys, tantalum based alloys, tungsten based alloys, and mixtures thereof.

The valve assembly comprises a housing having one or more entrance ports through which fluid enters the valve assembly and one or more exit ports through which fluid exits the valve assembly, the one or more entrance ports and the one or more exit ports being in fluid communication via a chamber extending from the one or more entrance ports to the one or more exit ports within the housing. The valve assembly further comprises a plug disposed within the chamber in a normally open position, and a translating member, such as a spring, in mechanical communication with the plug, the translating member biasing the plug in the direction of the one or more entrance ports. The plug and the translating member cooperate to provide a flow resistance actuated by the force exerted on the plug by fluid entering the valve assembly such that the flow resistance increases with increased force exerted on the plug. The plug may have one or more fluid flow channels longitudinally disposed within said plug which allow fluid to flow through the plug. The one or more exit ports may receive at least a portion of the plug upon force being applied on the plug by the fluid entering the one or more one entrance ports.

### BRIEF DESCRIPTION OF THE DRAWINGS

FIG. 1, is a depiction of the fluid flow regulating valve assembly in accordance with the present invention.

FIG. 2, is an exploded view of the fluid flow regulating valve assembly shown in FIG. 1.

### DETAILED DESCRIPTION OF THE PREFERRED EMBODIMENTS OF THE INVENTION

The present invention discloses a valve assembly for regulating the flow of a fluid from a high pressure environment to a low pressure environment based on the difference in pressure between the high pressure environment and the low pressure environment. As used herein, a fluid may be any substance in liquid or gaseous form. When the pressure differential between the high pressure environment is great, the flow resistance provided by the valve is increased which may substantially limit or cease the flow of the liquid through the valve. As the pressure differential between the high pressure environment and the low pressure environment decreases, the flow resistance provided by the valve is decreased. When the pressure differential between the high pressure environment and the low pressure environment is nominal or equalized, the valve provides minimal flow resistance, if any, to the fluid flowing through the valve.

The present invention is useful for providing flow resistance to a fluid flowing from a high pressure environment to a low pressure environment which prevents the fluid from entering the low pressure environment at too fast of a rate. The present invention is particularly useful for regulating the flow of a high pressure hydrogen stream being supplied to a hydrogen storage vessel utilizing a hydrogen storage alloy to store hydrogen in metal hydride form. Metal hydride hydrogen storage units typically comprise a pressure containment vessel at least partially filled with a hydrogen storage alloy selected from Rare-earth metal alloys, Misch metal based alloys, zirconium based alloys, titanium based alloys, magnesium based alloys, magnesium/nickel based alloys, tantalum based alloys, tungsten based alloys, and mixtures or alloys thereof. When hydrogen storage alloys absorb hydrogen, heat of hydride formation is produced as a result of the formation of a metal hydride. When refueling metal hydride hydrogen storage units, if too much hydrogen is supplied to the hydrogen storage alloy in too short of a time, the metal hydride hydrogen storage unit may not be able to adequately remove the heat of hydride formation which may result in longer refueling times. Excess heat of hydride formation may also damage or weaken the hydrogen storage vessel and/or the components used in connection therewith. By using the valve assembly in accordance with the present invention, the amount of hydrogen flowing into the metal hydride hydrogen storage vessel may be regulated thereby limiting the amount of heat produced by the absorption of hydrogen into the hydrogen storage alloy to levels which can be adequately removed from the system. While the valve assembly is particularly useful for regulating the flow of a high pressure hydrogen stream into a metal hydride hydrogen storage vessel, the valve assembly may be used for other applications where the flow of a fluid stream from a high pressure environment to a low pressure environment needs to be regulated.

The valve assembly generally comprises a housing having at one or more entrance ports, through which a fluid enters the valve assembly, and one or more exit ports through which the fluid exits the valve assembly. The one or more entrance ports and the one or more exit ports of the housing are in fluid communication with each other via a chamber extending from the one or more entrance ports to the one or more exit ports within the housing. The one or more entrance ports are adapted to receive a fluid and the one or more exit ports are adapted to distribute the fluid received by the one or more entrance ports.

A flow resistance plug is disposed within the chamber of the valve assembly. The plug is normally in an open position. The plug has a first side facing the first port and a second side facing the second port. Upon application of a force on the first side of the plug by a fluid entering the valve assembly, the plug is pushed toward the one or more exit ports thereby restricting or ceasing the flow of the fluid through the valve assembly. The second side of the plug and the one or more exit ports may also be designed such that the one or more exit ports receive at least a portion of the second side of the plug thereby restricting or preventing the flow of the fluid through the one or more exit ports based on the force applied on the first side of the plug by the fluid entering the valve assembly. The plug may have one or more flow channels longitudinally disposed within the plug extending from the first side to the second side of the plug which allow for fluid flow through the plug. The plug may have any number of configurations provided that the plug is capable of restricting or ceasing the flow of the fluid based on the force exerted on the plug in the direction of the one or more exit ports from the fluid entering the first port of the valve assembly. A translating member, such as a spring, in mechanical communication with the plug biases the plug in the direction of the one or more entrance ports. As fluid enters and flows through the valve assembly, the translating member cooperates with the plug to provide a flow resistance based on tension provided by the translating member on the plug and the force exerted on the plug in the direction of the one or more exit ports by the fluid entering the valve assembly. During use, fluid flows around the plug and/or through the fluid flow channels in the plug and flows out of the one or more exit ports.

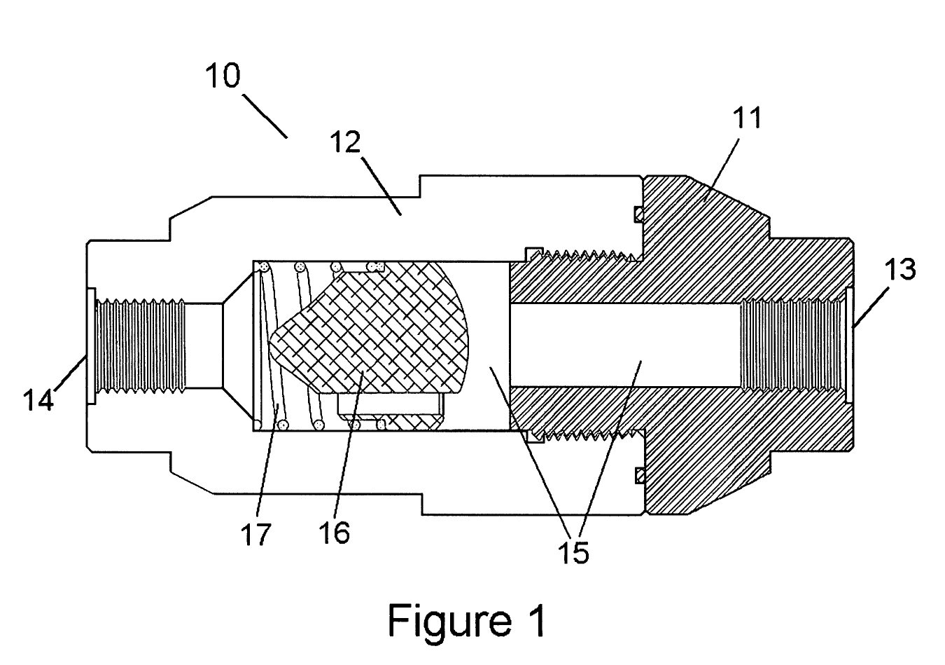

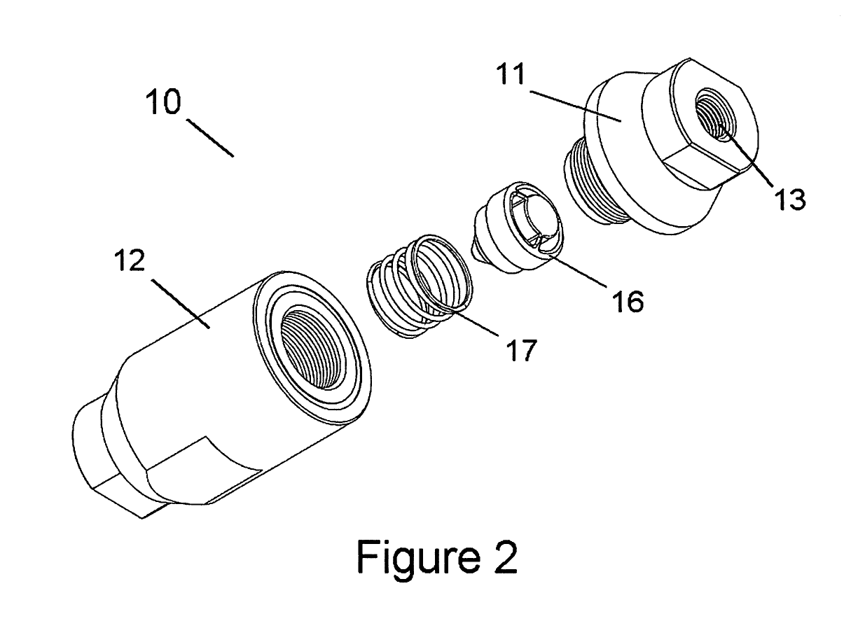

A preferred embodiment of the valve assembly in accordance with the present invention is shown in FIG. 1 and FIG. 2. The valve assembly 10 includes a housing including a first section 11 and a second section 12 which screw together to form the housing. The first section 11 includes an entrance port through which fluid enters the valve assembly 10 and the second section 12 includes an exit port 14 through which fluid exits the valve assembly 10. When the first section 11 and the second section 12 are screwed together to form the housing, a chamber 15 is formed between the entrance port 13 and the exit port 14 within the housing. The valve assembly further includes a flow resistance plug 16 disposed in the chamber such that the flow resistance plug may move longitudinally in the chamber. The plug has a first side facing the entrance port and a second side facing the exit port. The second side of the plug is configured such that at least a portion of the second side may be received by the exit port. The second side of the plug has a conical configuration such that the cone extends away from the second side of the plug toward the exit port. The plug 16 includes one of more flow channels extending from the first side to the second side which allow a fluid to flow through the plug. A spring 17 is disposed between the plug and the exit port. During use the spring 17 provides resistance to the plug 16 as the plug is pushed toward the exit port by the force exerted on the first side of the plug by the fluid entering the entrance port of the valve assembly. Based on the force applied on the first side of the plug by the fluid entering the entrance port, the flow of the fluid through the valve assembly may be restricted or ceased.

The valve assembly components may be constructed from any rigid material able to withstand the operating conditions inside or outside of the valve assembly. The interior components or the valve assembly should have little or no reactivity with the fluid designed to pass through the valve assembly. Suitable materials may include metals, polymers, or any other rigid materials.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A valve assembly for regulating the flow of hydrogen gas in a metal hydride hydrogen storage system, said valve assembly comprising:
a housing having one or more entrance ports through which fluid enters said valve assembly and one or more exit ports through which fluid exits said valve assembly, said one or more entrance ports and said on or more exit ports being in fluid communication via a chamber extending from said one or more entrance ports to said one or more exit ports within said housing;
a plug disposed within said chamber in a normally open position; and
a translating member in mechanical communication with said plug, said translating member biasing said plug in the direction of said one or more entrance ports;
said plug and said translating member cooperating to provide a flow resistance actuated by the force exerted on said plug in the direction of said one or more exit ports by fluid entering said valve assembly such that said flow resistance increases with increased force exerted on said plug.

2. The valve assembly according to claim 1, wherein said plug comprises one or more fluid flow channels longitudinally disposed within said plug.

3. The valve assembly according to claim 1, wherein one or more of said one or more exit ports receive at least a portion of said plug upon force being applied on said plug in the direction of said one or more exit ports by fluid entering said one or more entrance ports.

4. The valve assembly according to claim 1, wherein said translating member is a spring.

5. A metal hydride hydrogen storage system comprising:
a source of gaseous hydrogen;
a pressure containment vessel at least partially filled with a hydrogen storage alloy;
a pressure regulating valve providing gaseous communication between said source of gaseous hydrogen and said pressure containment vessel, said pressure regulating valve including:
a housing having one or more entrance ports through which hydrogen enters said valve assembly and one or more exit ports through which hydrogen exits said valve assembly, said one or more entrance ports and said one or more exit ports being in gaseous communication via a chamber extending from said one or more entrance ports to said one or more exit ports within said housing;
a plug disposed within said chamber in a normally open position; and
a translating member in mechanical communication with said plug, said translating member biasing said plug in the direction of said one or more entrance ports;
said plug and said translating member cooperating to provide a flow resistance actuated by the force exerted on said plug in the direction of said one or more exit ports by hydrogen entering said valve assembly such that said flow resistance increases with increased force exerted on said plug.

6. The hydrogen storage system according to claim 5, wherein said one or more exit ports receive at least a portion of said plug upon force being applied on said plug in the direction of said one or more exit ports by fluid entering said one or more entrance ports.

7. The hydrogen storage system according to claim 5, wherein said plug comprises one or more fluid flow channels longitudinally disposed within said plug.

8. The hydrogen storage system according to claim 5, wherein said translating member is a spring.

9. The hydrogen storage system according to claim 5, wherein said hydrogen storage alloy is selected from Rare-earth metal alloys, Misch metal based alloys, zirconium based alloys, titanium based alloys, magnesium based alloys, magnesium/nickel based alloys, tantalum based alloys, tungsten based alloys, and mixtures thereof.
